(19) United States
(12) Patent Application Publication
(10) Pub. No.: US 2025/0253111 A1
(43) Pub. Date: Aug. 7, 2025

(54) MAGNETIC SWITCH FOR A VEHICLE STARTER

(71) Applicant: MAHLE International GmbH, Stuttgart (DE)

(72) Inventor: Jaka Stanic, Nova Gorica (SI)

(21) Appl. No.: 19/046,496

(22) Filed: Feb. 5, 2025

(30) Foreign Application Priority Data
Feb. 6, 2024 (DE) 102024103252.9

(51) Int. Cl. H01H 50/14; F02N 11/08; H01H 50/02; H01H 50/16

(52) U.S. Cl. CPC H01H 50/14; F02N 11/087; H01H 50/02; H01H 50/16

(57) ABSTRACT

The invention relates to a solenoid switch for a motor vehicle starter. The solenoid switch has a housing and two terminals. In addition, the solenoid switch has a cover that closes the terminals to the outside.

### CROSS REFERENCE TO RELATED APPLICATION

This application claims priority to German Patent Application No. DE102024103252.9, filed on Feb. 6, 2024, the contents of which is hereby incorporated by reference in its entirety.

### TECHNICAL FIELD

The invention relates to a solenoid switch for a starter of a vehicle.

### BACKGROUND

A starter normally consists of a starter engine with an exciter coil and a solenoid switch. The solenoid switch turns on the starter engine by making electrical contact between a battery of the motor vehicle and an exciter coil of the starter engine when the corresponding control signal is received. To do this, the solenoid switch is connected to the vehicle's battery and to the exciter coil via corresponding terminals so that electricity can flow. Usually, the starter has a common housing for the starter engine and the solenoid switch. The terminals of the solenoid switch are also arranged in the common housing so that they are protected against manipulative external interference-for example, against the starter and thus the vehicle being started without the corresponding control signal by bridging or short-circuiting the terminals. However, if the solenoid switch is not located directly adjacent to the exciter coil or the starter engine, the terminals of the solenoid switch are not protected and can be manipulated from the outside.

### SUMMARY

The object of the invention is therefore to provide an improved or at least alternative embodiment of a solenoid switch of the type according to the prior art, in which the disadvantages described are overcome.

According to the invention, this task is solved by the object of independent claim(s). Advantageous embodiments are the object of the dependent claim(s).

The present invention is based on the general idea of covering the terminals of the solenoid switch and thereby preventing the terminals from being bridged or short-circuited and the starter or the motor vehicle from being started by manipulation.

The solenoid switch according to the invention is provided or designed for a starter of a motor vehicle. The solenoid switch has a housing with a first longitudinal end axial to its longitudinal center axis. In addition, the solenoid switch has a first terminal for connecting to a battery of the motor vehicle and a second terminal for connecting to an exciter winding of the starter of the motor vehicle. The terminals project axially out of the housing at the first longitudinal end of the housing. The solenoid switch also has a contact plug with contacts for controlling the solenoid switch and a wall. The wall of the contact plug extends at the first longitudinal end of the housing out of the housing axially outwards and goes around the contacts of the contact plug. According to the invention, the solenoid switch has a cover, wherein the cover is arranged in a form-fitting and non-detachable manner at the first longitudinal end of the housing. The terminals are fully enclosed in the cover and the wall of the contact plug extends axially outwards from the cover.

In the solenoid switch according to the invention, the cover encloses the terminals from the outside and can thus prevent tampering. In particular, the cover can prevent the terminals from being bridged or short-circuited from the outside without an appropriate control signal, thereby preventing the starter or the motor vehicle from being started by manipulation. The cover is non-detachably arranged at the longitudinal end of the housing so that the cover cannot be removed. The cover can be designed as a standard part, for example, and used with all solenoid switches of the type described.

The housing of the solenoid switch, for example, can be hollow cylindrical and closed at the first longitudinal end. The terminals and the contact plug can protrude from the housing at the first longitudinal end so that the solenoid switch or the terminals of the solenoid switch can be connected to the battery of the motor vehicle and to the exciter coil of the starter. The contact plug is not completely closed by the cover, so that the contacts are open to the outside. This allows the solenoid switch or starter to be connected and controlled from the outside.

In one possible embodiment, the contact plug can have a stop edge formed on the wall and lying outside the cover. The stop edge can run around the wall and project outwards from the wall perpendicular to the longitudinal center axis of the housing. The cover can then strike axially on one side against the stop edge of the contact plug and on the other side against the housing, and thus be fixed axially to the housing. In other words, the cover can be wedged or clamped between the stop edge of the contact plug and the housing, thereby fixing it axially. This arrangement of the cover on the housing prevents the cover from being detached from the housing, while the contacts of the contact plug remain accessible from the outside. This means that the terminals of the solenoid switch can be closed and protected from the outside, while the solenoid switch can also be contacted and controlled from the outside via the contacts of the contact plug.

The cover can have at least one pin that protrudes outwards from the cover. The pin may be shaped at an angle to the longitudinal center axis of the housing and to the wall of the contact plug. The cover can then be closed and the pin will rest against the stop edge of the contact plug. Since the pin is shaped at an angle to the wall, the pin that is attached to the stop edge of the wall can no longer be moved over the stop edge of the wall. This allows the cover to be securely and permanently attached to the housing.

The cover can have exactly two or exactly three pins, wherein the pins can be molded onto the cover around the wall of the contact plug. This means that the cover can also be securely attached to the housing radially.

The respective pin can be elastically deformable. When mounting the cover on the housing, the cover can then be guided axially past the stop edge of the contact plug wall and then behind the stop edge of the contact plug wall. This allows the cover to be mounted on the housing by simply pushing it on. As described above, the pin is shaped at an angle to the wall, so the cover cannot be removed from the housing once assembly is complete, or only with a great deal of effort.

In one possible embodiment, the cover can have a peripheral area and the peripheral area can encircle the housing at the first longitudinal end of the housing in a peripheral direction around the longitudinal center axis, at least in some areas, and the cover can thus be radially fixed to the housing. The cover can therefore at least partially enclose the housing on the outside at the first longitudinal end and thus be securely attached to the housing. The recirculation area in particular can prevent the cover from slipping radially off the housing.

In one possible embodiment, the housing can have an axially protruding molding at the first longitudinal end and a recess corresponding to the molding can be formed on the cover. In this case, the molding can engage axially in the recess, thereby fixing the cover to the housing in a torsion-resistant manner. The molding can be arranged between the terminals, for example, and separate them within the cover. This can prevent the two terminals from being accidentally short-circuited. The molding of the housing can form an axial stop for the cover. In other words, the cover can strike the molding axially on one side, preventing further movement of the cover through the molding. The molding and the stop edge of the contact plug can be designed in such a way that the cover is axially clamped or wedged between them.

In one possible embodiment, the cover can have at least one opening for draining condensed water from the cover. The opening allows the water condensed in the cover to drain freely, thus preventing the terminals from rusting.

The cover can be molded from a dielectric material, preferably plastic. At least the first longitudinal end of the housing can be molded from a dielectric material, preferably plastic. In particular, this can prevent an electrically conductive connection between the terminals through the housing.

In the context of the present invention, the terms “axial” and “radial” always refer to the longitudinal center axis of the housing.

Further important features and advantages of the invention are apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF DRAWINGS

It shows, schematically in each case:

FIGS. 1 and 2 exploded views of a solenoid switch according to the invention with a cover in a first embodiment in different views;

FIG. 3 a plan view of the solenoid switch according to the invention with the cover in the first embodiment;

FIG. 4 a sectional view of the solenoid switch according to the invention with the cover in the first embodiment with a radial cut;

FIGS. 5 and 6 sectional views of the solenoid switch according to the invention with the cover in the first embodiment with axial sections perpendicular to each other;

FIGS. 7 through 10 show sectional views of the solenoid switch according to the invention with the cover in the first embodiment during the assembly of the cover;

FIG. 11 a view of the cover of the solenoid switch according to the invention in a second embodiment;

FIGS. 12 and 13 side views of the cover of the solenoid switch according to the invention in the second embodiment; and

FIGS. 14 and 15 a plan view and a rear view of the cover of the solenoid switch according to the invention in the second embodiment.

### DETAILED DESCRIPTION

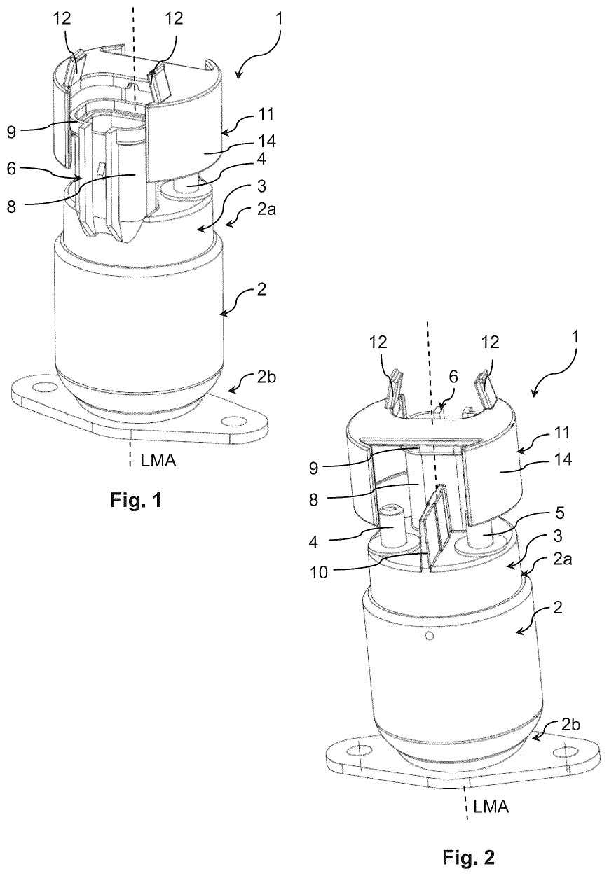

FIG. 1 and FIG. 2 show exploded views of a solenoid switch 1 for a starter of a motor vehicle according to the invention. The solenoid switch 1 has a housing 2 with a longitudinal center axis LMA. With regard to the longitudinal center axis LMA, the housing 2 has a first axial longitudinal end 2a and a second axial longitudinal end 2b. The housing 2 is cylindrical and has a section 3 molded from plastic at the first longitudinal end 2a.

Furthermore, the solenoid switch 1 has a first terminal 4 for connection to a battery of the motor vehicle and a second terminal 5 for connection to an exciter winding of the starter of the motor vehicle. The terminals 4 and 5 are arranged at the first longitudinal end 2a of the housing 2 and project axially out of the housing 2. Furthermore, the solenoid switch 1 comprises a contact plug 6 with contacts 7 for controlling the solenoid switch 1 and a wall 8. The wall 8 protrudes axially outwards from the housing 2 at the first longitudinal end 2a of the housing 2 and runs around the contacts 7. The contact plug 6 has a stop edge 9, which is formed on the wall 8 and arranged outside the cover 11. The stop edge 9 runs around the wall 8 and extends outwards at right angles to the longitudinal center axis LMA of the housing 2 from the wall 8.

Furthermore, a molding 10 is formed on the housing 2, which projects axially at the first longitudinal end 2b of the housing 2 and separates the two terminals 4 and 5 from each other.

The solenoid switch 1 also has a cover 11. The cover 11 is formed separately from the housing 2 and is non-detachably fixed to the longitudinal end 2a of the housing 2 in a form-fitting manner. In the first embodiment, the cover 11 has two pins 12 that project axially outwards and are inclined towards the wall 8. Furthermore, a recess 13 is formed on the cover 11—see FIG. 6—in which the molding 10 can engage axially. In addition, a peripheral area 14 is formed on the cover 11, which can partially enclose the housing 2 at the first longitudinal end 2a from the outside.

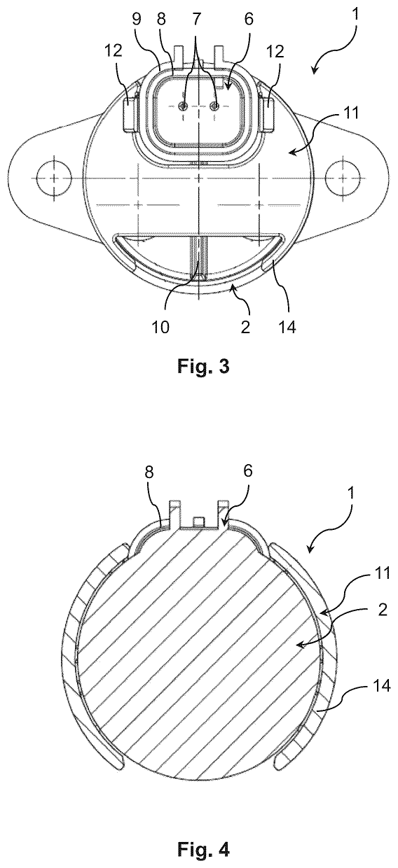

The cover 11 is non-detachably fixed to the longitudinal end 2a of the housing 2 and prevents a manipulative short circuit of the two terminals 4 and 5. The arrangement and the fixing of the cover 11 to the housing 2 are described in more detail below, with reference to FIG. 3 through FIG. 10.

FIG. 3 shows a top view of the solenoid switch 1 according to the invention with the cover 11 in the first embodiment. As can be seen in FIG. 3, the cover 11 is arranged at the first longitudinal end 2a of the housing 2. In this case, the pins 12 of the cover 11 are shaped around the contact plug 6 and rest against the wall 8 of the contact plug 6 below the stop edge 9. The cover 11 surrounds the terminals 4 and 5 in sections from the outside and leaves the contacts 7 of the contact plug 6 open to the outside and accessible from the outside.

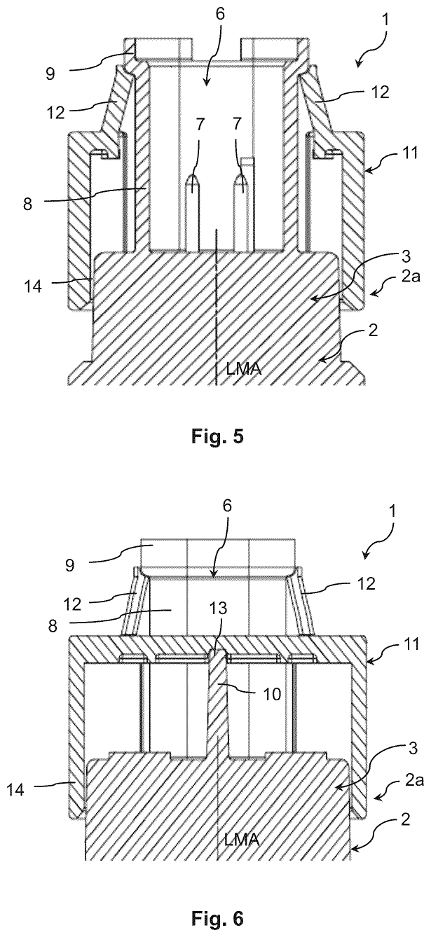

FIG. 4 shows a sectional view of the solenoid switch 1 according to the invention with the cover 11 in the first embodiment with a radial cut. FIG. 4 shows that the cover 11 with its peripheral area 14 encloses the housing 2 in the section 3 or at the first longitudinal end 2a from the outside. This fixes the cover 11 radially to the housing 2.

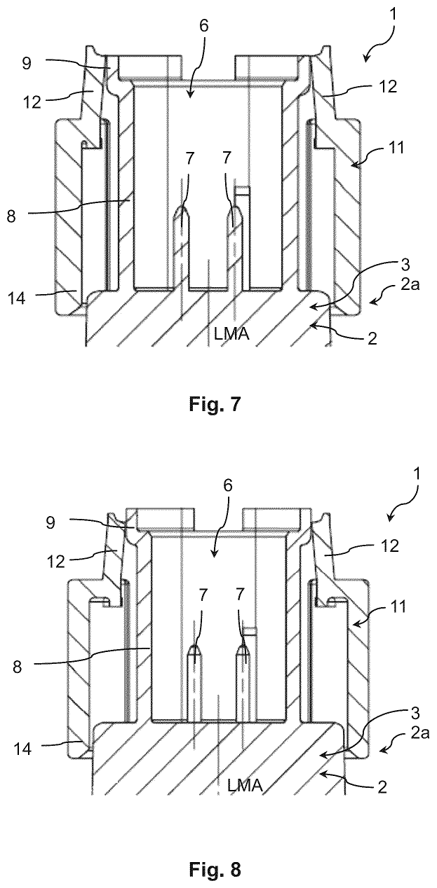

FIG. 5 shows a sectional view of the solenoid switch 1 according to the invention with the cover 11 in the first embodiment with an axial section through the pins 12 of the cover 11. As can be seen particularly well in FIG. 5, the pins 12 of the cover 11 rest against the wall 8 of the contact plug 6 and axially against the stop edge 9 of the contact plug 6, and are supported by it. This limits the axial movement of the cover 11 away from the housing 2 and secures it axially at the longitudinal end 2a of the housing 2.

FIG. 6 shows a sectional view of the solenoid switch 1 according to the invention, with the cover 11 in the first embodiment, with an axial section through the molding 10 of the housing 2. As can be seen particularly well in FIG. 6, the cover 11 rests axially against the molding 10 of the housing 2 and is limited in its axial movement towards the housing 2 and is axially fixed at the longitudinal end 2a of the housing 2. In this case, the molding 10 of the housing 2 engages axially in the recess 13 of the cover 11, so that the cover 11 is also fixed to the housing 2 in a rotationally secure manner.

With reference to FIG. 5 and FIG. 6, the stop edge 9 of the contact plug 6 and the molding 10 of the housing 2 form stops axially on both sides for the cover 11, so that the cover is arranged axially between the housing 2 and the stop edge 9 of the contact plug 6, or is clamped axially, or is wedged axially. Due to the shape of the pins 12 of the cover 11, the cover 11 can no longer be removed from the housing 2 after installation is complete.

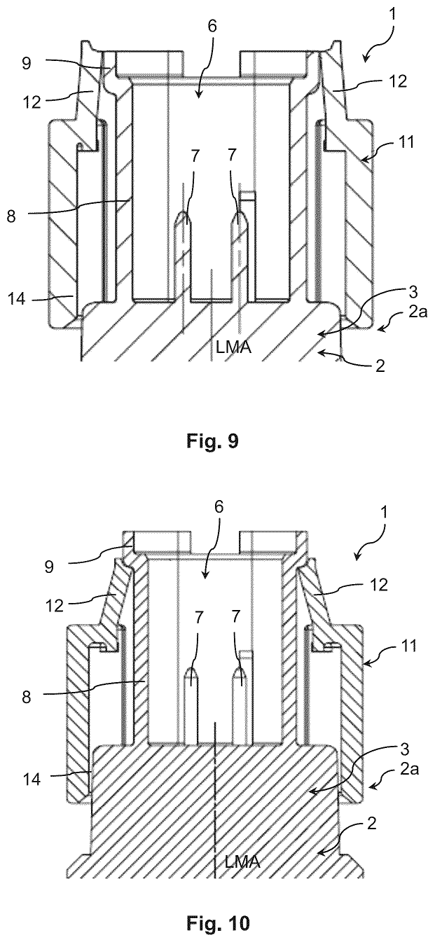

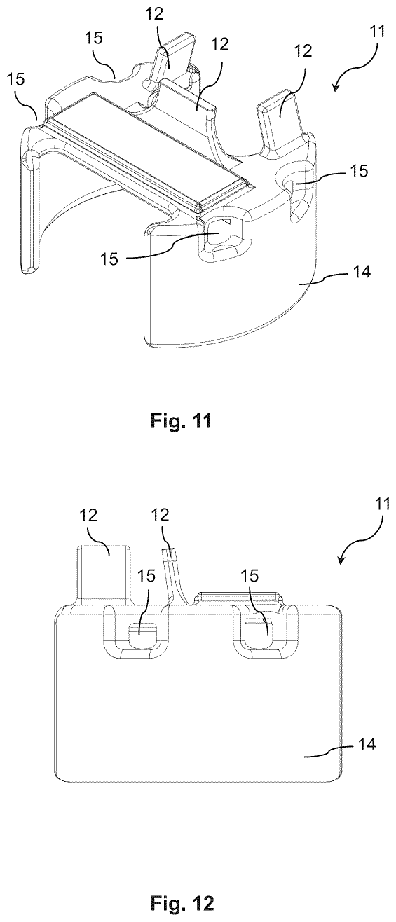

FIG. 7 through FIG. 10 show sectional views of the solenoid switch 1 according to the invention with the cover 11 in the first embodiment when the cover 11 is mounted on the housing 2. In the process, the cover 11 is guided axially over the contact plug 6 and its stop edge 9 to the housing 2, as shown in FIG. 7 through FIG. 9. The pins 12 elastically deform outwards at the stop edge 9 of the contact plug 6 and the circumferential area 14 slides axially on the housing 2. As shown in FIG. 11, the pins 12 are then guided behind the stop edge 9 and engage with the stop edge 9. At the same time, the cover 11 also axially engages with the molding 10 of the housing 2—see FIG. 6. The cover 11 is now axially fixed to the housing 2, since axial movement of the cover 11 is prevented on one side by the pins 12 and on the other side by the molding 10 of the housing 2.

In FIG. 4 through FIG. 10, the housing 2 of the solenoid switch 1 is shown as a solid body for the sake of simplicity. However, it is understood that further elements of the solenoid switch 1 can be arranged within the housing.

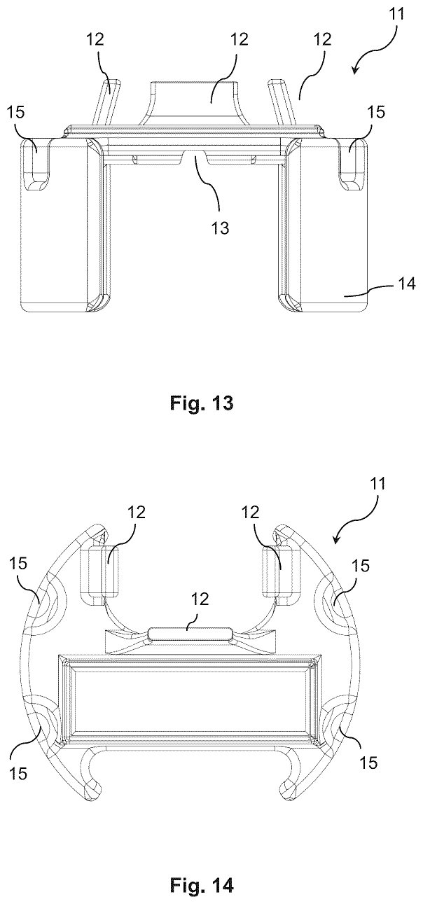

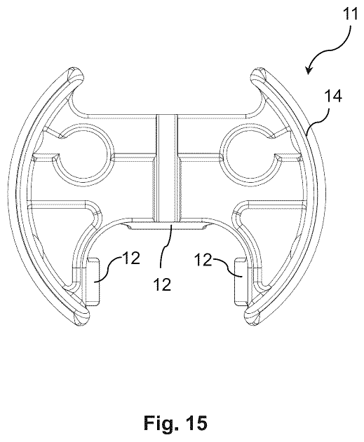

FIG. 11 shows a view of the cover 11 in a second embodiment. FIG. 12 and FIG. 13 show side views of the cover 11 in the second embodiment. FIG. 14 shows a top view and FIG. 15 shows a rear view of the cover 11 in the second embodiment. In contrast to the first embodiment, the cover 11 has exactly three pins 12, which are formed around the contact plug 6. The cover 11 can be particularly securely hooked to the stop edge 9 of the contact plug 6 by means of the pins 12. Furthermore, four through-holes 15 are formed in the cover 11 for draining condensed water.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments de-scribed and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or de-scribed in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or com-ponents, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if”' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A solenoid switch for a starter of a motor vehicle, the solenoid switch comprising:
a housing having a first longitudinal end aligned axially with a longitudinal center axis of the housing;
a first terminal configured to connect to a battery of the motor vehicle and a second terminal configured to connect to an exciter winding of the starter of the motor vehicle;
wherein the first terminal and the second terminal are disposed at the first longitudinal end of the housing, the first terminal and the second terminal projecting axially outward from the housing,
a contact plug with contacts for controlling the solenoid switch and a wall;
wherein the wall of the contact plug is disposed at the first longitudinal end of the housing, projecting axially outward from the housing, and surrounding the contacts,
a cover arranged in a form-fitting and non-detachable manner on the first longitudinal end of the housing;
wherein the terminals are enclosed within the cover, and
wherein the wall of the contact plug extends axially out of the cover to the outside.

2. The solenoid switch according to claim 1, wherein:
the contact plug has a stop edge on the wall, the stop edge being located outside the cover,
the stop edge runs around the wall and projects outward from the wall perpendicular to the longitudinal center axis of the housing, and
the cover is axially secured to the housing by abutting the stop edge of the contact plug on one side and abutting the housing on the other side.

3. The solenoid switch according to claim 2, wherein:
the cover includes at least one pin extending outward from a portion of the cover,
the at least one pin is inclined at an angle relative to both the longitudinal center axis of the housing and to the wall of the contact plug, and
the cover, including the at least one pin, is in axial contact with the stop edge of the contact plug.

4. The solenoid switch according to claim 3, wherein:
the at least one pin is elastically deformable, allowing the cover to be guided axially past the stop edge of the contact plug during mounting, and
upon passing the stop edge, the cover is positioned behind the stop edge of the contact plug, securing the cover to the housing.

5. The solenoid switch according to claim 3, wherein:
the at least one pin includes two pins or three pins, and
the two pins or three pins are distributed around the wall of the contact plug and disposed on the cover.

6. The solenoid switch according to claim 1, wherein:
the cover has a peripheral region that extends at least partially around the housing at the first longitudinal end of the housing in a peripheral direction about the longitudinal center axis; and
the peripheral region radially secures the cover to the housing.

7. The solenoid switch according to claim 1, wherein:
a molding projects axially from the first longitudinal end of the housing,
a recess corresponding to the molding is disposed on the cover, and
the molding engages axially in the recess, thereby securing the cover to the housing in a rotationally secure manner.

8. The solenoid switch according to claim 7, wherein:
the molding of the housing is arranged between the first terminal and the second terminal and separates the first terminal and the second terminal from one another inside the cover, and
the molding of the housing is an axial stop for the cover.

9. The solenoid switch according to claim 1, wherein the cover has at least one opening for draining condensed water from the cover.

10. The solenoid switch according to claim 1, wherein:
the cover is molded from a dielectric material, and
at least the first longitudinal end of the housing is molded from a dielectric material.

11. The solenoid switch according to claim 7, wherein the molding of the housing is arranged between the first terminal and the second terminal and separates the first terminal and the second terminal from one another inside the cover.

12. The solenoid switch according to claim 7, wherein the molding of the housing is an axial stop for the cover.

13. The solenoid switch according to claim 1, wherein the cover is made of a dielectric material.

14. The solenoid switch according to claim 13, wherein the dielectric material is plastic.

15. The solenoid switch according to claim 1, wherein at least the first longitudinal end of the housing is made of a dielectric material.

16. The solenoid switch according to claim 15, wherein the dielectric material is plastic.

17. The solenoid switch according to claim 4, wherein the at least one pin includes two pins or three pins and the two pins or three pins are distributed around the wall of the contact plug and disposed on the cover.

18. A solenoid switch for a starter of a motor vehicle, the solenoid switch comprising:
a housing having a first longitudinal end aligned axially with a longitudinal center axis of the housing;
a first terminal configured to connect to a battery of the motor vehicle and a second terminal configured to connect to an exciter winding of the starter of the motor vehicle;
wherein the first terminal and the second terminal are disposed at the first longitudinal end of the housing, the first terminal and the second terminal projecting axially outward from the housing,
a contact plug with contacts for controlling the solenoid switch and a wall;
wherein the wall of the contact plug is disposed at the first longitudinal end of the housing, projecting axially outward from the housing, and surrounding the contacts,
a cover arranged on the first longitudinal end of the housing;
wherein the terminals are enclosed within the cover, and
wherein the wall of the contact plug extends axially out of the cover to the outside.

19. The solenoid switch according to claim 18, wherein:
the contact plug has a stop edge on the wall, the stop edge being located outside the cover,
the stop edge runs around the wall and projects outward from the wall perpendicular to the longitudinal center axis of the housing, and
the cover is axially secured to the housing by abutting the stop edge of the contact plug on one side and abutting the housing on the opposite side.

20. The solenoid switch according to claim 19, wherein:
the cover includes at least one pin extending outward from a portion of the cover,
the at least one pin is inclined at an angle relative to both the longitudinal center axis of the housing and to the wall of the contact plug, and
the cover, including the at least one pin, is in axial contact with the stop edge of the contact plug.
